(19) United States
(12) Patent Application Publication
(10) Pub. No.: US 2009/0073333 A1
(43) Pub. Date: Mar. 19, 2009

(54) LIQUID CRYSTAL DISPLAY

(75) Inventor: Tsuyoshi Kamada, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/211,441

(22) Filed: Sep. 16, 2008

(30) Foreign Application Priority Data
Sep. 18, 2007 (JP) 2007-240811

(51) Int. Cl. G09G 3/36

(52) U.S. Cl. 349/37

(57) ABSTRACT

A liquid crystal display includes a plurality of pixels arranged in a matrix form, in which each of the pixels includes a plurality of non-linear elements and a plurality of subpixel electrodes on a drive substrate, the plurality of subpixel electrodes being electrically connected to the plurality of non-linear elements, respectively, a voltage having a reverse polarity is applied to at least two of the plurality of subpixel electrodes on the same frame, and each of the at least two of the plurality of subpixel electrodes is divided into four or more divided subpixel electrodes, and at least four of the divided subpixel electrodes of the subpixel electrode to which a voltage having one polarity is applied are adjacent to divided subpixel electrodes of the subpixel electrode to which a voltage having the other polarity is applied on the top and bottom sides of the divided subpixel electrodes.

### CROSS REFERENCES TO RELATED APPLICATIONS

The present invention contains subject matter related to Japanese Patent Application JP 2007-240811 filed in the Japanese Patent Office on Sep. 18, 2007, the entire contents of which being incorporated herein by reference.

### BACKGROUND OF THE INVENTION

1. Field of the Invention

The present invention relates to a liquid crystal display specifically suitable for VA (Vertical Alignment) mode.

2. Description of the Related Art

In recent years, VA mode liquid crystal displays used in liquid crystal televisions and the like have utilized a novel technique called multi-pixel to improve viewing angle characteristics in gray levels. As shown in FIG. 9, each pixel is divided into a plurality of subpixels A and B, and the subpixel A increases its intensity according to an input gray level, and then the subpixel B increases its intensity later. To obtain superior viewing angle characteristics, it is desired to reduce the area of the subpixel A so that the area ratio of the subpixels A and B becomes approximately 1:2 rather than 1:1.

FIGS. 10A and 10B show configurations of pixel electrodes and a common electrode of the subpixels A and B, and FIG. 10C shows an equivalent circuit of them. There are some methods of having a potential difference between the subpixels A and B; however, in FIGS. 10A to 10C, for example, the case where dedicated thin film transistors TFT1 and TFT2 are arranged in the subpixels A and B, respectively, and two source bus lines SL1 and SL2 are arranged with respect to the same gate bus line GL to drive the thin film transistors TFT1 and TFT2 is shown.

The multi-pixel includes the thin film transistors TFT1 and TFT2, a liquid crystal device Clc1 constituting the subpixel A, a liquid crystal device Clc2 constituting the subpixel B, and capacitors Cst1 and Cst2. The gates of the thin film transistors TFT1 and TFT2 are connected to the gate bus line GL. The source of the thin film transistor TFT1 is connected to the source bus line SL1, and the drain of the thin film transistor TFT1 is connected to an end of the liquid crystal device Clc1 and an end of the capacitor Cst1. The source of the thin film transistor TFT2 is connected to the source bus line SL2, and the drain of the thin film transistor TFT2 is connected to an end of the liquid crystal device Clc2 and an end of the capacitor Cst2. The other end of the capacitor Cst1 and the other end of the capacitor Cst2 are connected to a capacitor bus line CL.

The pixel electrode Px1 for the subpixel A is connected to the thin film transistor TFT1, and the pixel electrode Px2 for the subpixel B is connected to the thin film transistor TFT2. As shown in an equivalent circuit diagram in FIG. 10C, the pixel electrode Px1 for the subpixel A and the pixel electrode Px2 for the subpixel B are electrically independent of each other, and a control circuit determines what kind of voltage is written to the pixel electrodes Px1 and Px2.

In the pixel electrodes Px1 and Px2, slits 112 for inclining liquid crystal molecules in a 45° direction are arranged as a configuration specific to VA mode. Some of the slits 112 are common slits for separating the pixel electrodes Px1 and Px2 from each other. On the other hand, a slit 122 for liquid crystal molecular alignment control is necessary for the common electrode 121 arranged on a facing substrate. As a liquid crystal molecular alignment control means on the facing substrate side, in some cases, an insulating projection (not shown) is formed on the common electrode 121. In FIG. 10A, the slit 122 of the common electrode 121 is shown by broken lines.

FIGS. 11A, 11B, 12A and 12B are illustrations for describing the width of the slit 112. A cell thickness d of the liquid crystal display, that is, a space between a TFT substrate 110 and a facing substrate 120 is typically approximately 4 μm. In the case where the width of the slit 112 is sufficiently wide with respect to the cell thickness d, as shown in FIG. 11A, the equipotential surface of the slit 112 enters deep into glass of the TFT substrate 110, and in the slit 112, an electric field in a vertical direction becomes weaker. Therefore, as shown in FIG. 11B, while the vertical alignment of the liquid crystal molecules 131 in the slit 112 is maintained, an electric field in an oblique direction is sufficiently generated on the pixel electrodes Px1 and Px2 in proximity to the slit 112, and the alignment direction of liquid crystal molecules becomes stable.

In the slit 112, the liquid crystal molecules 131 are not inclined, and do not contribute to transmittance, so when the width of the slit 112 is increased, a substantial aperture ratio declines, thereby the transmittance declines. On the other hand, when the width of the slit 112 is reduced, the aperture ratio is increased, but as shown in FIG. 12A, an electric field in proximity to the slit 112 gradually becomes less oblique, and as shown in FIG. 12B, the alignment stability of the liquid crystal molecules 131 is deteriorated. When the direction angles of the liquid crystal molecules 131 are shifted from 45°, the effect of the liquid crystal molecules 131 on polarization is changed, so transmittance per unit area is reduced, and even if the aperture ratio is increased, overall transmittance declines.

In other words, as shown in FIG. 13, the width of the slit 112 with respect to transmittance has an optimum value, and the optimum width of the slit 112 with respect to the cell thickness d of 4 μm is typically designed to be approximately 10 μm.

FIG. 14 shows the alignment of the liquid crystal molecules 131 in the slit 112 in the case where a voltage having a reverse polarity is applied to two pixel electrodes Px1 and Px2. In this case, in great contrast to FIGS. 11A and 12A, the equipotential surface vertically enters into the slit 112 between the pixel electrodes Px1 and Px2. Moreover, in the slit 112, a place having the same potential as that of the common electrode 121 is typically formed. In the place having the same potential, the liquid crystal molecules 131 are not inclined and are aligned in a vertical direction, and the liquid crystal molecules 131 become extremely stable. On the other hand, an oblique electric field is strong, so as a result, the alignment of the liquid crystal molecules 131 becomes extremely stable. In addition, the smaller the width of the slit 112 is, the more the effect is enhanced.

FIGS. 15A and 15B show illustrations in the case where in consideration of the effect, assuming that a voltage having a reverse polarity is applied to two pixel electrodes Px1 and Px2 in the multi-pixel shown in FIGS. 10A to 10C, slits 112A between the pixel electrodes Px1 and Px2 are narrowed. Slits 112B in the lower left corner and the upper left corner and the slit 122 of the common electrode 121 of the facing substrate 120 are not slits between the electrodes Px1 and Px2, so they are designed as before.

FIG. 16 shows transmittance in the case where the width of the slit 112A is reduced as in the case shown in FIGS. 15A and 15B. It is clear from FIG. 16 that in the case where a voltage having the same polarity is applied to two pixel electrodes Px1 and Px2 (same polarity driving), when the width of the slit 112 is 10 μm or less, the transmittance declines due to deterioration in the liquid crystal molecular alignment; however, in the case where a voltage having a reverse polarity is applied to two pixel electrodes Px1 and Px2 (reverse polarity driving), when the slit 112A is narrowed, the transmittance is able to be improved (for example, refer to Japanese Unexamined Patent Application Publication No. 2005-316211).

### SUMMARY OF THE INVENTION

A distance x between the slits 112 and 122 has a large influence on VA mode response characteristics, and in the case where a cell thickness d is 4 μm, the distance x is typically designed to be approximately 25 μm. To speed up the response of the liquid crystal display, it is necessary to further reduce the distance x between the slits 112 and 122. Moreover, when liquid crystal television screens become larger, each pixel becomes larger.

These two directions have the same influence on the design of the pixel. In other words, to speed up the response, it is necessary to arrange more slits 112 as liquid crystal molecular alignment control means in one pixel. FIG. 17 shows an illustration in which the number of slits 112 of the pixel electrodes Px1 and Px2 shown in FIG. 15 is increased. However, the number of slits 112A which are allowed to be narrowed by reverse polarity driving out of 12 slits 112 on the TFT substrate is only 4. The other eight slits 112B and the slits 122 of the common electrode 121 of the facing substrate 120 are forced to be designed as before. Moreover, when the size of each pixel is increased, there is a possibility that the number of slits 112 is increased more than that in FIG. 17, and it is important to further enhance an effect of narrowing a slit by reverse polarity driving.

In view of the foregoing, it is desirable to provide a liquid crystal display capable of increasing the number of slits which are allowed to be narrowed by reverse polarity driving, and further enhancing an effect of narrowing a slit.

According to an embodiment of the invention, there is provided a liquid crystal display including a plurality of pixels arranged in a matrix form, in which each of the pixels includes a plurality of non-linear elements and a plurality of subpixel electrodes on a drive substrate, the plurality of subpixel electrodes being electrically connected to the plurality of non-linear elements, respectively, a voltage having a reverse polarity is applied to at least two of the plurality of subpixel electrodes on the same frame, and each of the at least two of the plurality of subpixel electrodes is divided into four or more divided subpixel electrodes, and at least four of the divided subpixel electrodes of the subpixel electrode to which a voltage having one polarity is applied are adjacent to divided subpixel electrodes of the subpixel electrode to which a voltage having the other polarity is applied on the top and bottom sides of the divided subpixel electrodes.

In the liquid crystal display according to the embodiment of the invention, at least four of divided subpixel electrodes of the subpixel electrode to which a voltage having one polarity is applied are adjacent to divided subpixel electrodes of the subpixel electrode to which a voltage having the other polarity is applied on the top and bottom sides of the divided subpixel electrodes, so the divided subpixel electrodes of the subpixel electrode to which a voltage having one polarity is applied and the divided subpixel electrodes of the subpixel electrode to which a voltage having the other polarity is applied are alternately arranged. Therefore, slits between them are able to be narrowed by reverse polarity driving, and transmittance is improved by the stability of liquid crystal molecular alignment.

In the liquid crystal display according to the embodiment of the invention, at least four of divided subpixel electrodes of the subpixel electrode to which a voltage having one polarity is applied are adjacent to divided subpixel electrodes of the subpixel electrode to which a voltage having the other polarity is applied on the top and bottom sides of the divided subpixel electrodes, so more slits are able to be narrowed by reverse polarity driving. Therefore, an effect of narrowing a slit which is that liquid crystal molecular alignment is stabilized to improve transmittance is further enhanced. Moreover, when the number of slits is increased, VA mode response characteristics are able to be improved, so the liquid crystal display according to the embodiment of the invention is advantageous to speed up the response, and is extremely suitable for increasing the size of each pixel with an increase in the size of a screen.

Other and further objects, features and advantages of the invention will appear more fully from the following description.

### BRIEF DESCRIPTION OF THE DRAWINGS

FIG. 1 is an illustration showing the whole configuration of a liquid crystal display including a liquid crystal display panel according to a first embodiment of the invention;

FIG. 2 is an equivalent circuit diagram of a pixel of the liquid crystal display panel shown in FIG. 1;

FIG. 3 is a sectional view showing a configuration of a part of the liquid crystal display panel shown in FIG. 1;

FIG. 4 is a plan view of a pixel electrode shown in FIG. 3;

FIG. 5 is an illustration showing transmittance in the embodiment;

FIG. 6 is a plan view of pixel electrodes of a liquid crystal display according to a second embodiment of the invention;

FIGS. 7A and 7B are a plan view of a pixel electrode shown at each of the upper left and the lower right in FIG. 6 and a plan view of a pixel electrode shown at each of the upper right and the lower left in FIG. 6, respectively;

FIGS. 8A and 8B are illustrations showing a simulation result of the transmittance of a pixel in a related art;

FIG. 9 is an illustration showing an example of displaying gray levels by a multipixel in a related art;

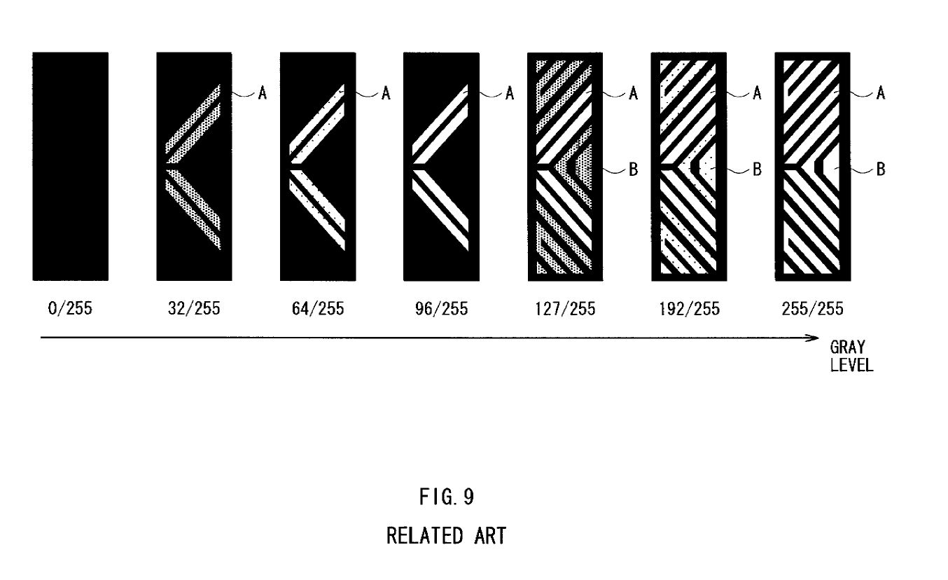

FIGS. 10A, 10B and 10C are illustrations and an equivalent circuit diagram showing configurations of a pixel electrode in each sub pixel shown in FIG. 9 and a common electrode;

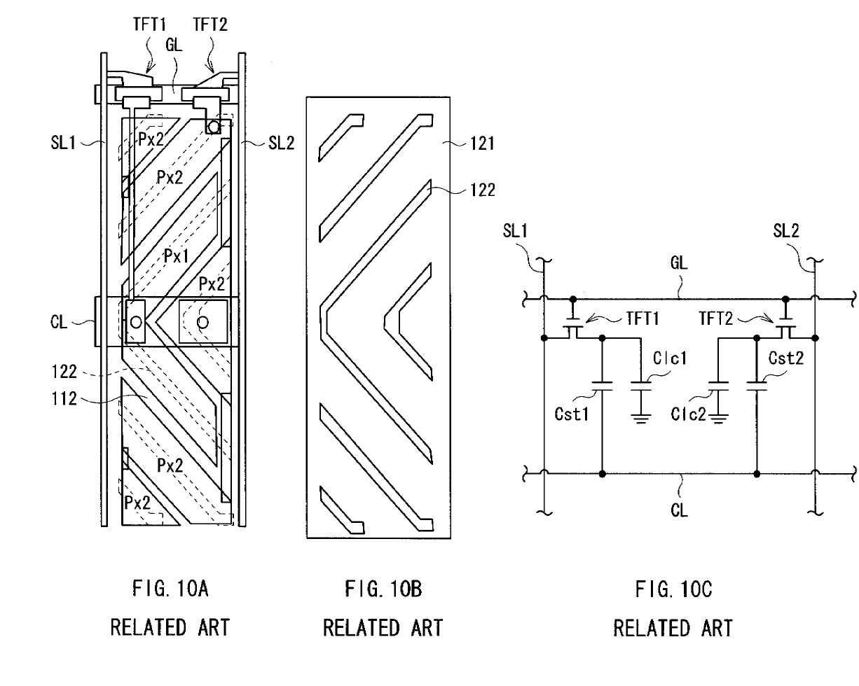

FIGS. 11A and 11B are illustrations for describing the width of a slit shown in FIGS. 10A, 10B and 10C;

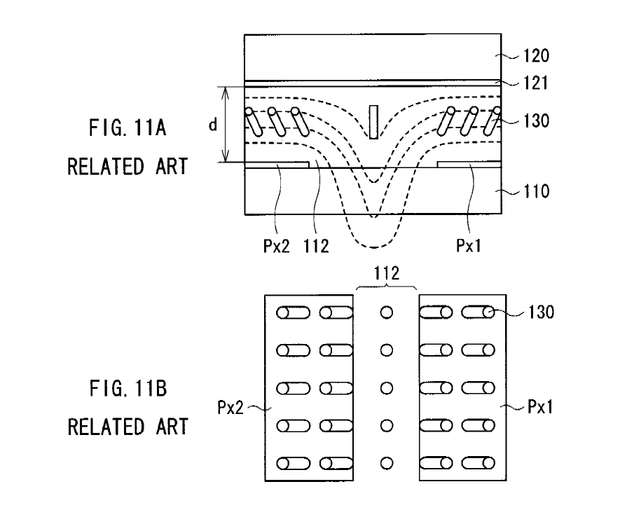

FIGS. 12A and 12B are illustrations for describing the width of the slit shown in FIGS. 10A, 10B and 10C;

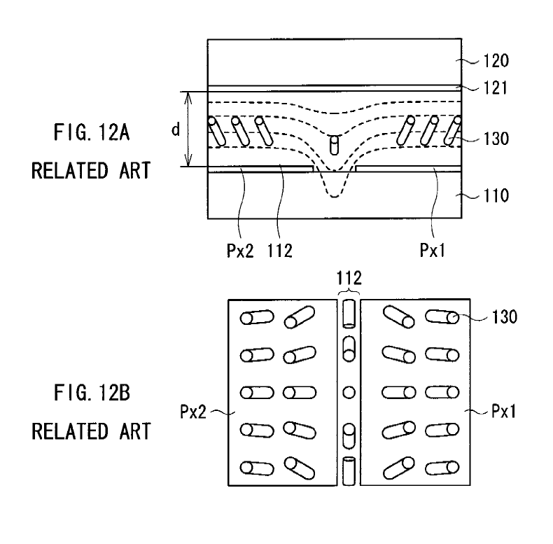

FIG. 13 is an illustration showing a relationship between the width of the slit and transmittance;

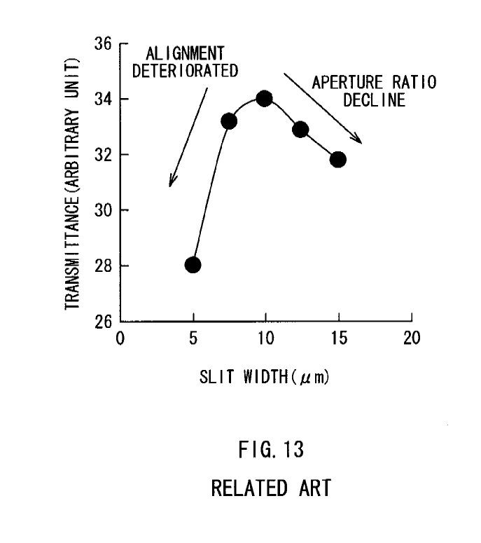

FIG. 14 is an illustration for describing the alignment of liquid crystal molecules in the slit in the case where a voltage having a reverse polarity is applied to two pixel electrodes shown in FIGS. 10A, 10B and 10C;

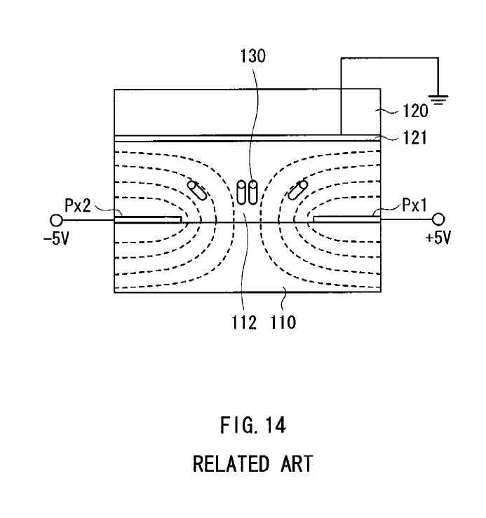

FIGS. 15A and 15B are plan views showing the configuration of a pixel in reverse polarity driving;

FIG. 16 is an illustration showing transmittance in the case where the width of the slit is reduced; and

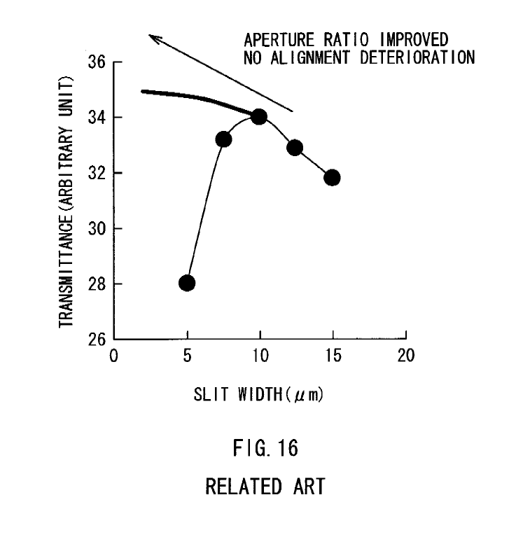

FIG. 17 is a plan view for describing an issue in increasing the number of slits in the pixel shown in FIGS. 15A and 15B.

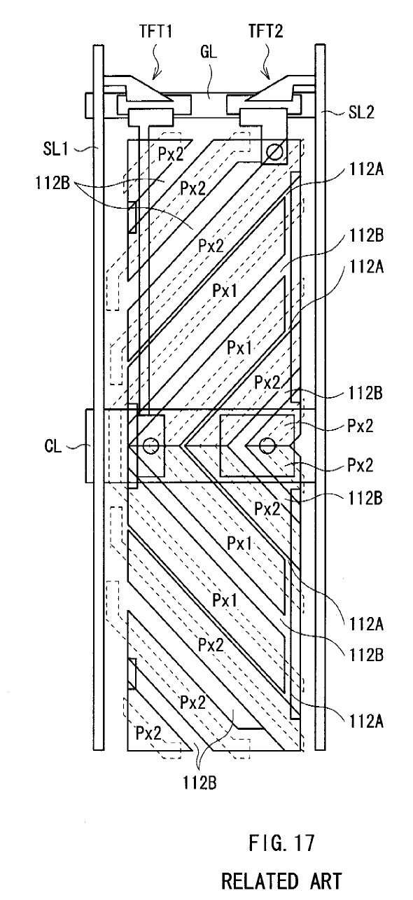

### DETAILED DESCRIPTION OF THE PREFERRED EMBODIMENTS

Preferred embodiments will be described in detail below referring to the accompanying drawings.

### First Embodiment

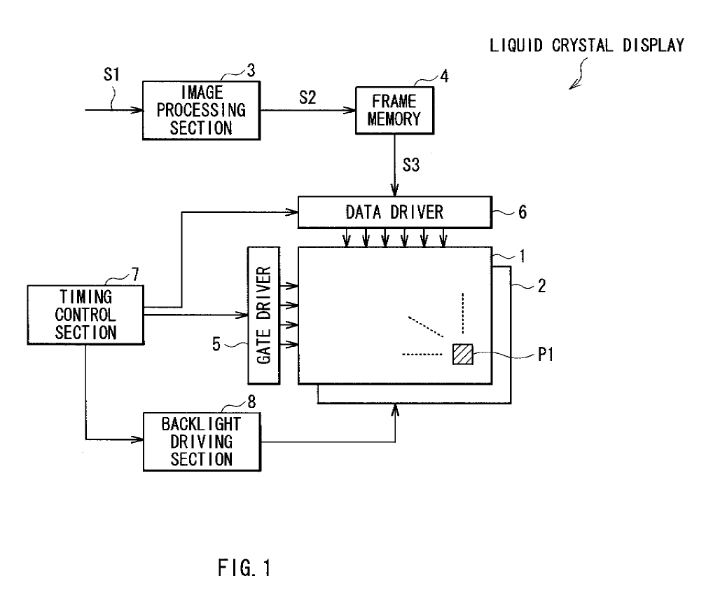

FIG. 1 shows the configuration of a liquid crystal display according to a first embodiment of the invention. The liquid crystal display is a VA mode liquid crystal display used for a liquid crystal television or the like, and the liquid crystal display includes, for example, a liquid crystal display panel 1, a backlight section 2, an image processing section 3, a frame memory 4, a gate driver 5, a data driver 6, a timing control section 7 and a backlight driving section 8.

The liquid crystal display panel 1 displays an image on the basis of a video signal Di transmitted from the data driver 6 in response to a driving signal supplied from the gate driver 5, and includes a plurality of pixels P1 arranged in a matrix form, and the liquid crystal display panel 1 is an active matrix liquid crystal display panel in which each pixel P1 is driven. A specific configuration of the pixel P1 will be described later.

The backlight section 2 is a light source applying light to the liquid crystal display panel 1, and includes, for example, a CCFL (Cold Cathode Fluorescent Lamp) an LED (Light Emitting Diode) or the like.

The image processing section 3 performs predetermined image processing on a video signal S1 from outside to produce a video signal S2 which is an RGB signal.

The frame memory 4 stores the video signal S2 supplied from the image processing section 3 for each pixel P in a frame.

The timing control section 7 controls the timing of driving the gate driver 5, the data driver 6 and the backlight driving section 8. Moreover, the backlight driving section 8 controls the illumination operation of the backlight section 2 according to the timing control of the timing control section 7.

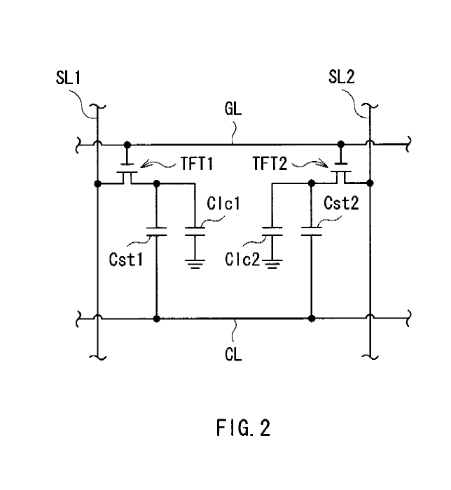

Referring to FIGS. 2 to 4, the specific configuration of each pixel P1 of the liquid crystal display panel 1 will be described below. Each pixel P1 has a multipixel configuration including two subpixels, and displays, for example, any one of primary colors red (R), green (G) and blue (B).

FIG. 2 shows the equivalent circuit of the pixel P1. The pixel P1 includes thin film transistors TFT1 and TFT2, a liquid crystal device Clc1 constituting one subpixel (hereinafter referred to as subpixel A), a liquid crystal device Clc2 constituting another subpixel (hereinafter referred to as subpixel B), and capacitors Cst1 and Cst2.

The thin film transistors TFT1 and TFT2 each have a function as a switching device for supplying a video signal S3 to the subpixels A and B, and are made of, for example, an MOS-FET (Metal Oxide Semiconductor-Field Effect Transistor), and each of the thin film transistors TFT1 and TFT2 includes three electrodes, a gate, a source and a drain. The gates of the thin film transistors TFT1 and TFT2 are connected to a gate bus line GL extending in a horizontal direction. Two source bus lines SL1 and SL2 extending in a vertical direction is orthogonal to the gate bus line GL. The source of the thin film transistor TFT1 is connected to the source bus line SL1, and the drain of the thin film transistor TFT1 is connected to an end of the liquid crystal device Clc1 and an end of the capacitor Cst1. The source of the thin film transistor TFT2 is connected to the source bus line SL2, and the drain of the thin film transistor TFT2 is connected to an end of the liquid crystal device Clc2 and an end of the capacitor Cst2.

The liquid crystal devices Clc1 and Clc2 each have a function as a display device performing an operation for display in response to a signal voltage supplied through the thin film transistors TFT1 and TFT2. The other end of the liquid crystal device Clc1 and the other end of the liquid crystal device Clc2 constitute a common electrode on a substrate surface with a liquid crystal in between.

The capacitors Cst1 and Cst2 generate a potential difference between an end of the capacitor Cst1 and an end of the capacitor Cst2, and more specifically, the capacitors Cst1 and Cst2 each include a dielectric storing an electrical charge. The other end of the capacitor Cst1 and the other end of the capacitor Cst2 are connected to a capacitor bus line CL extending in parallel to the gate bus line GL, that is, in a horizontal direction.

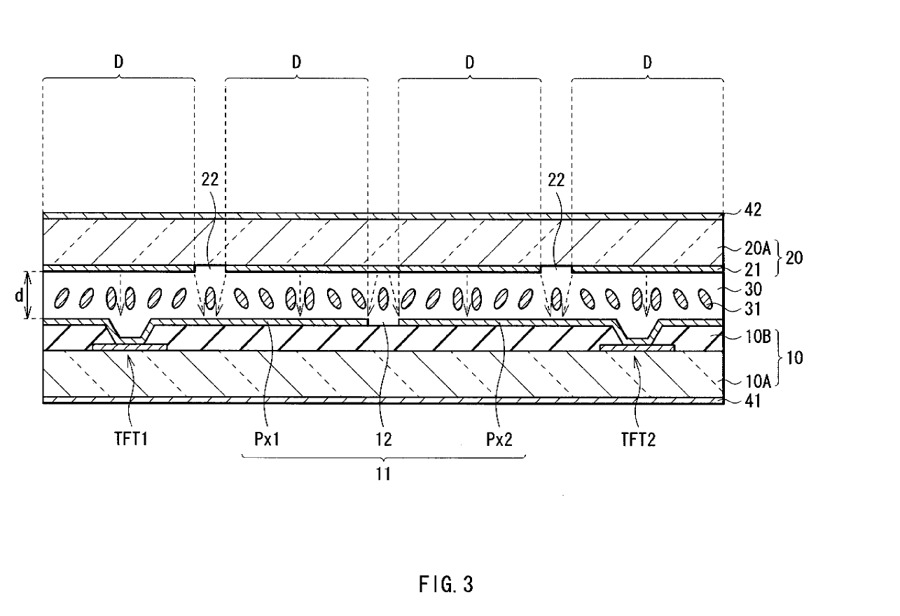

FIG. 3 shows a sectional view of the liquid crystal display panel 1. The liquid crystal display panel 1 includes a liquid crystal layer 30 between a TFT substrate (drive substrate) 10 and a facing substrate 20. Polarizing plates 41 and 42 are arranged on the TFT substrate 10 and the facing substrate 20, respectively, so that the optical axes (not shown) of the polarizing plates 41 and 42 are orthogonal to each other.

The TFT substrate 10 is formed by forming the thin film transistors TFT1 and TFT2, an interlayer insulating layer 10B, and the subpixel electrodes Px1 and Px2 made of ITO (Indium Tin Oxide) in each pixel P1 on the glass substrate 10A. The subpixel electrode Px1 constitutes a subpixel A, and is electrically connected to the thin film transistor TFT1. The subpixel electrode Px2 constitutes a subpixel B, and is electrically connected to the thin film transistor TFT2. The subpixel electrodes Px1 and Px2 constitutes one pixel electrode 11. A slit 12 for controlling liquid crystal molecular alignment is arranged between the subpixel electrodes Px1 and Px2. Capacitors Cst1 and Cst2 and the like shown in FIG. 2 (but not shown in FIG. 3) are arranged on the glass substrate 10A.

As shown in an equivalent circuit diagram in FIG. 2, the subpixel electrode Px1 and the subpixel electrode Px2 are electrically independent of each other, and a voltage having a reverse polarity is applied to the subpixel electrodes Px1 and Px2 in the same frame. Thereby, the width of the slit 12 in the pixel P1 is able to be reduced, and the transmittance is able to be improved.

The facing substrate 20 is formed by forming a common electrode 21 on a glass substrate 20A. A color filter and a black matrix or the like (both not shown) are formed on the glass substrate 20A. In the common electrode 21, a slit 22 for controlling the liquid crystal molecular alignment is arranged in a position where the slit 22 does not overlap the slit 12 of the pixel electrode 11.

The liquid crystal layer 30 is a VA mode liquid crystal layer, and includes liquid crystal molecules 31.

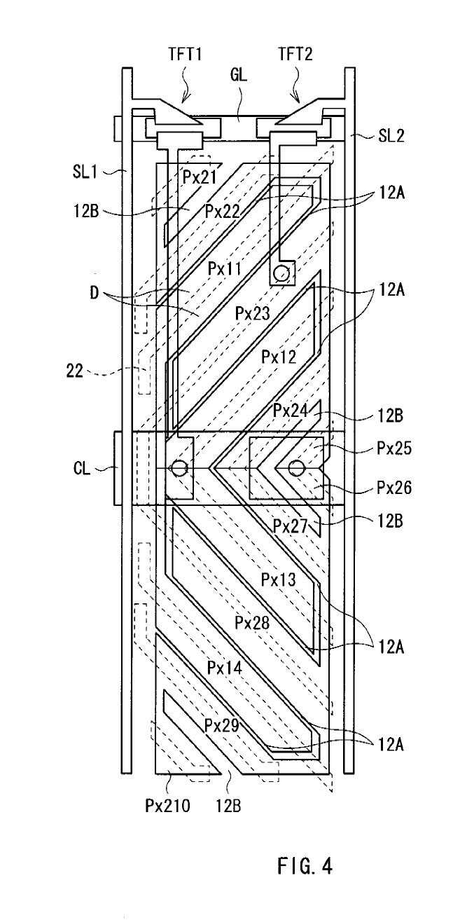

FIG. 4 shows the pixel electrode 11 of one pixel P1. The subpixel electrode Px1 is divided into four divided subpixel electrodes Px11, Px12, Px13 and Px14. The top and bottom sides of the divided subpixel electrodes Px11 to Px14 each form an angle of 45° with the optical axes of the polarizing plates 41 and 42. Moreover, the divided subpixel electrodes Px11 to Px14 each are divided into two domains D by the slit 22 of the common electrode 21, so the subpixel electrode Px1 includes eight domains D. In this case, the domain means a region in which the alignment directions of the liquid crystal molecules 31 when a voltage is applied are the same.

The subpixel electrode Px2 is divided into 10 divided subpixel electrodes Px21, Px22, Px23, Px24, Px25, Px26, Px27, Px28, Px29 and Px210. The top and bottom sides of the divided subpixel electrodes Px21 to Px210 each form an angle of 45° with the optical axes of the polarizing plates 41 and 42. The divided subpixel electrodes Px21 to Px210 each are divided into two domains D in the same manner, so the subpixel electrode Px2 includes 20 domains D.

The divided subpixel electrodes Px11, Px12, Px13 and Px14 of the subpixel electrode Px1 are adjacent to the divided subpixel electrodes Px22 and Px23, the divided subpixel electrodes Px23 and Px24, the divided subpixel electrodes Px27 and Px28, and the divided subpixel electrodes Px28 and Px29 of the subpixel electrode Px2 on the top and bottom sides of the divided subpixel electrodes Px11, Px12, Px13 and Px14, respectively. In other words, the divided subpixel electrodes Px22, Px11, Px23, Px12 and Px24 are arranged in this order, and the divided subpixel electrodes Px27, Px13, Px28, Px14 and Px29 are arranged in this order, and the widths of eight slits 12A between them are able to be reduced, and the other four slits 12B have the same width as before. Thereby, in the liquid crystal display, the number of slits 12A which are allowed to be narrowed by reverse polarity driving is able to be increased.

The configuration shown in FIG. 4 is applicable in the case where the subpixel electrode Px1 with a small area includes eight domains or more. Therefore, the subpixel electrode Px1 preferably includes a number (4+4*n) (n is an integer of n>0) of domains D in which the alignment directions of liquid crystal molecules when a voltage is applied are the same.

The divided subpixel electrodes Px11 to Px14 arranged at intervals are necessary to be electrically connected to one another by a connection pattern, thereby an aperture ratio may decline. However, in the embodiment, more slits 12A are able to be narrowed, so a better effect is obtained. The same holds for the divided subpixel electrodes Px21 to Px210.

The liquid crystal display is able to be manufactured by a typical manufacturing method, except that the subpixel electrodes Px1 and Px2 are formed in a shape shown in FIG. 4.

In the liquid crystal display panel 1, as shown in FIG. 1, the image processing section 3 performs image processing on the video signal S1 supplied from outside so as to produce the video signal S2 for each pixel P1. The video signal S2 is stored in the frame memory 4, and the video signal S2 is supplied to the data driver 6 as the video signal S3. On the basis of the video signal S3 supplied in such a manner, line-sequential display driving operation is performed in each pixel P1 by a driving voltage outputted from the gate driver 5 and the data driver 6 to each pixel P1. More specifically, the thin film transistors TFT1 and TFT2 turn on and off in response to a selection signal supplied from the gate driver 5 through the gate bus line GL so that the source bus line SL and the pixel P1 are selectively brought into conduction. Thereby, illumination light from the backlight section 2 is modulated by the liquid crystal display panel 1 to be outputted as display light.

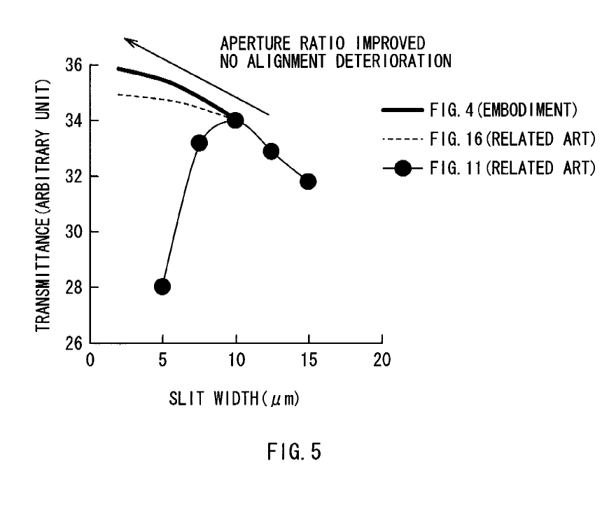

In this case, the divided subpixel electrodes Px11, Px12, Px13 and Px14 of the subpixel electrode Px1 are adjacent to the divided subpixel electrodes Px22 and Px23, the divided subpixel electrodes Px23 and Px24, the divided subpixel electrodes Px27 and Px28, and the divided subpixel electrodes Px28 and Px29 of the subpixel electrode Px2, respectively, so the divided subpixel electrodes Px22, Px11, Px23, Px12 and Px24 are arranged in this order, and the divided subpixel electrodes Px27, Px13, Px28, Px14 and Px29 are arranged in this order. Therefore, the widths of eight slits 12A between them are able to be reduced, and as shown in FIG. 5, an effect of narrowing a slit which is that transmittance is improved by the stability of liquid crystal molecular alignment is further improved.

Thus, in the embodiment, the divided subpixel electrodes Px11, Px12, Px13 and Px14 of the subpixel electrode Px1 are adjacent to the divided subpixel electrodes Px22 and Px23, the divided subpixel electrodes Px23 and Px24, the divided subpixel electrodes Px27 and Px28, and the divided subpixel electrodes Px28 and Px29 of the subpixel electrode Px2, respectively, so eight slits 12A are able to be narrowed by reverse polarity driving. Therefore, an effect of narrowing a slit which is that liquid crystal molecular alignment is stabilized to improve transmittance is able to be further improved. Moreover, when the number of slits 12 is increased, VA mode response characteristics are able to be improved, so the liquid crystal display according to the embodiment is advantageous to speed up the response, and is extremely suitable for increasing the size of each pixel with an increase in the size of a screen.

### Second Embodiment

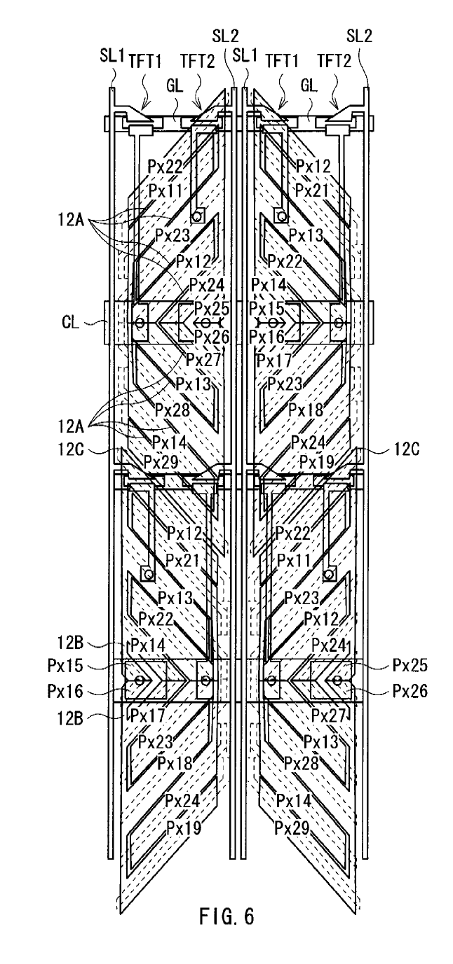

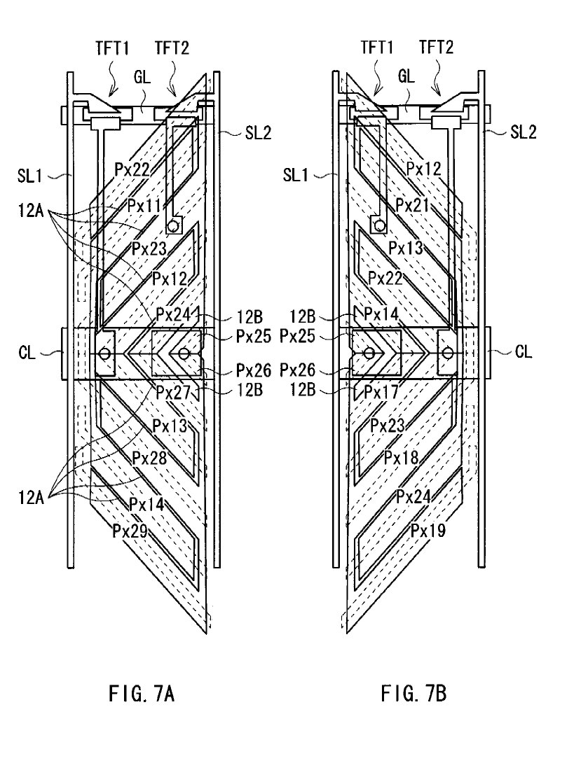

FIG. 6 shows pixel electrodes 11 of four pixels P1 which are arranged in a liquid crystal display according to a second embodiment of the invention. FIG. 7A shows the pixel electrode 11 shown at each of the upper left and the lower right in FIG. 6, and FIG. 7B shows the pixel electrode 11 at each of the upper right and the lower left in FIG. 6. In the liquid crystal display according to the embodiment, the outside shape of the pixel electrode 11 is changed to improve the transmittance in corners of the pixel P1, and except for this, the liquid crystal display according to the embodiment has the same configuration as that in the first embodiment. Therefore, like components are denoted by like numerals.

In the pixel electrodes 11 shown at the upper left and the lower right in FIG. 6, as shown in FIG. 7A, the subpixel electrode Px1 is divided into four divided subpixel electrodes Px11 to Px14, and the subpixel electrode Px2 is divided into eight divided subpixel electrodes Px22 to Px29. On the other hand, in the pixel electrodes 11 at the upper right and the lower left in FIG. 6, as shown in FIG. 7B, the subpixel electrode Px2 is divided into four divided subpixel electrodes Px21 to Px24, and the subpixel electrode Px1 is divided into eight divided subpixel electrodes Px12 to Px19.

In other words, in the embodiment, triangular divided subpixel electrodes disposed in corners of the pixel P1 (the divided subpixel electrodes Px21 and Px210 in the first embodiment) are removed, and the outside shape of the pixel electrode 11 is a vertically oriented trapezoid arranged at 90°. The right and left sides of the pixel electrode 11 are parallel sides of the trapezoid, and are parallel to the optical axes of the polarizing plates 41 and 42. The top and bottom sides of the pixel electrode 11 are inclined sides, and are inclined 45°, 135°, 225° or 315° from the optical axes of the polarizing plates 41 and 42. Thereby, in the embodiment, the transmittance in the corners of the pixel P1 is able to be improved.

The pixel electrode 11 is line-symmetrically arranged with adjacent pixel electrodes 11 on the right and left sides of the pixel electrode 11 with respect to a vertical axis. Moreover, the pixel electrode 11 is point-symmetrically arranged with adjacent pixel electrodes 11 on the top and bottom sides of the pixel electrode 11, and the top and bottom sides of the pixel electrode 11 and the top and bottom sides of the adjacent pixel electrodes on the top and bottom sides of the pixel electrode 11 are parallel to one another. Thereby, a wasted space is able to be eliminated.

Moreover, in the pixel electrodes 11 shown at the upper left and the lower right in FIG. 6, as shown in FIG. 7A, the divided subpixel electrodes Px11, Px12, Px13 and Px14 of the subpixel electrode Px1 are adjacent to the divided subpixel electrodes Px22 and Px23, the divided subpixel electrodes Px23 and Px24, the divided subpixel electrodes Px27 and Px28, and the divided subpixel electrodes Px28 and Px29 of the subpixel electrode Px2 on the top and bottom sides of the divided subpixel electrodes Px11, Px12, Px13 and Px14, respectively. In other words, the divided subpixel electrodes Px22, Px11, Px23, Px12 and Px24 are arranged in this order, and the divided subpixel electrodes Px27, Px13, Px28, Px14 and Px29 are arranged in this order, and the widths of eight slits 12A between them are able to be reduced, and only the remaining 2 slits 12B have the same width as before.

On the other hand, in the pixel electrodes 11 shown at the upper right and the lower left in FIG. 6, as shown in FIG. 7B, the divided subpixel electrodes Px21, Px22, Px23 and Px24 of the subpixel electrode Px2 are adjacent to the divided subpixel electrodes Px12 and Px13, the divided subpixel electrodes Px13 and Px14, the divided subpixel electrodes Px17 and Px18, and the divided subpixel electrodes Px18 and Px19 of the subpixel electrode Px1 on the top and bottom sides of the divided subpixel electrodes Px21, Px22, Px23 and Px24, respectively. In other words, the divided subpixel electrodes Px12, Px21, Px13, Px22 and Px14 are arranged in this order, and the divided subpixel electrodes Px17, Px23, Px18, Px24 and Px19 are arranged in this order, and the widths of eight slits 12A between them are able to be reduced, and only the remaining 2 slits 12B have the same width as before.

Thus, in the embodiment, as in the case of the first embodiment, the ratio of the slits 12A which are allowed to be narrowed by reverse polarity driving is able to be increased.

Moreover, in the pixel electrode 11, a polarity relationship between a plurality of subpixel electrodes Px1 and Px2 is preferably opposite to that in the adjacent pixel electrodes 11 on the top and bottom sides or the right and left sides of the pixel electrode 11. It is because a slit 12C between adjacent pixel electrodes 11 is able to be narrowed, and transmittance is able to be further improved.

The liquid crystal display is able to be manufactured by a typical manufacturing method, except that the pixel electrode 11 is formed in an outside shape shown in FIGS. 6, 7A and 7B.

In the liquid crystal display panel 1, as shown in FIG. 1, as in the case of the first embodiment, line-sequential display driving operation is performed in each pixel P1, and illumination light from the backlight section 2 is modulated by the liquid crystal display panel 1 to be outputted as display light.

In this case, the outside shape of the pixel electrode 11 is a trapezoid in which the right and left sides are parallel to the optical axes of the polarizing plates 41 and 42, and the top and bottom sides are inclined at 45°, 135°, 225° or 315° with respect to the optical axes of the polarizing plates 41 and 42, so a contradiction between the alignment directions of the liquid crystal molecules 31 and the outside shape of the pixel electrode 11 is resolved. Therefore, the deviation of φ (direction angles) of the liquid crystal molecules in the corners of the pixel P1 is reduced, and transmittance is improved.

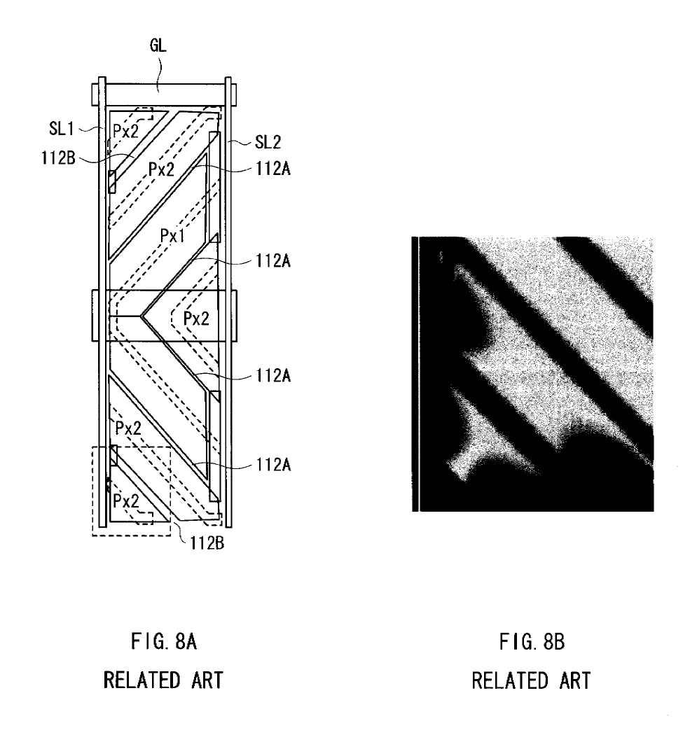

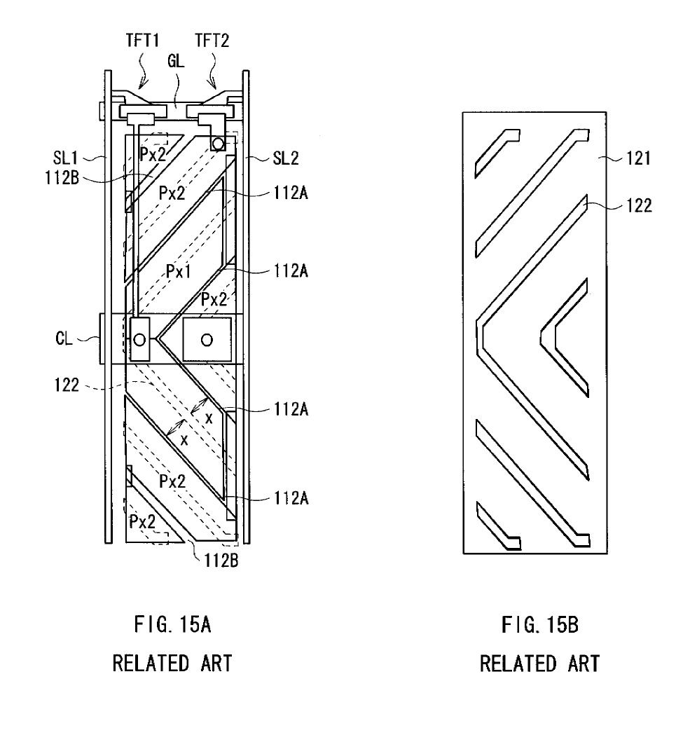

On the other hand, FIG. 8A shows a pixel which is the same as a pixel in a related art shown in FIG. 15, and FIG. 8B shows a simulation result of the transmittance of the pixel shown in FIG. 8A, and shows an enlarged view of an area surrounded by a dotted line in the lower left corner of the pixel shown in FIG. 8A. An area in the upper left corner is not specifically shown; however, it may be considered that except that the direction angle is different, the result is substantially the same.

It is clear from FIG. 8B that in the related art, the transmittance in the corners of the pixel is very low. As the cause, mismatch between the basic shape of the pixel and the alignment directions of liquid crystal molecules is cited. When the liquid crystal molecules are inclined in a 45° direction, the transmittance is maximized because of a relationship with the optical axis of a polarizing plate. Therefore, the slit 112 is arranged at 45°. However, the basic shape of the pixel is a rectangle, so in the corners of the pixel, the direction angles of the liquid crystal molecules are shifted (φ deviation) by the influence of the patterns of the pixel electrodes Px1 and Px2 cut in a vertical direction and a horizontal direction. In particular, in the corners of the pixel, the φ deviation is centralized on the right and left ends and the top and bottom ends, so a decline in transmittance is pronounced.

Thus, in the embodiment, the outside shape of the pixel electrode is a trapezoid in which the right and left sides are parallel to the optical axis of the polarizing plate, and the top and bottom sides are inclined at 45°, 135°, 225° or 315° with respect to the optical axis of the polarizing plate, so the φ deviation in the corners of the pixel is able to be reduced, and the transmittance is able to be improved.

Although the present invention is described referring to the embodiments, the invention is not limited to the above-described embodiments, and may be variously modified. For example, in the first embodiment, the case where the subpixel electrode Px1 is divided into four divided subpixel electrodes Px11 to Px14, and the four divided subpixel electrodes Px11, Px12, Px13 and Px14 are adjacent to the divided subpixel electrodes Px22 and Px23, PX23 and Px24, Px27 and Px28, and Px28 and Px29 of the subpixel electrode Px2, respectively, is described; however, the subpixel electrode Px1 may be divided into four or more divided subpixel electrodes. In this case, at least four divided subpixel electrodes of the divided subpixel electrodes may be adjacent to the divided subpixel electrodes of the subpixel electrode Px2.

Moreover, for example, in the second embodiment, the case where the outside shape of the pixel electrode 11 is a trapezoid is described; however, in the invention, the outside shape of the pixel electrode 11 is not limited to a trapezoid, and the invention is applicable to the case where the outside shape of the pixel electrode 11 is a shape in which the top and bottom sides are inclined at 45°, 135°, 225° or 315° with respect to the optical axis of the polarizing plate such as a parallelogram.

For example, in the above-described embodiments, an example in which each pixel is divided into two subpixels is described; however, the invention is applicable to the case where each pixel is divided into three or more subpixels.

Moreover, the shape of the subpixel is not limited to the shapes in the above-described embodiments, and the subpixel may have any other shape, for example, a square shape or a rectangular shape, and the subpixel may have a configuration in which the plane area of the pixel is substantially divided.

In addition, in the above-described embodiments, the case where the thin film transistors TFT1 and TFT2 are used as non-linear elements is described as an example; however, the non-linear element may be a TFD (Thin Film Diode).

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display comprising a plurality of pixels arranged in a matrix form,
wherein each of the pixels includes a plurality of non-linear elements and a plurality of subpixel electrodes on a drive substrate, the plurality of subpixel electrodes being electrically connected to the plurality of non-linear elements, respectively,
a voltage having a reverse polarity is applied to at least two of the plurality of subpixel electrodes on the same frame, and each of the at least two of the plurality of subpixel electrodes is divided into four or more divided subpixel electrodes, and
at least four of the divided subpixel electrodes of the subpixel electrode to which a voltage having one polarity is applied are adjacent to divided subpixel electrodes of the subpixel electrode to which a voltage having the other polarity is applied on the top and bottom sides of the divided subpixel electrodes.

2. The liquid crystal display according to claim 1, wherein
the subpixel electrode to which a voltage having one polarity is applied includes a number (4+4*n) (n is an integer of n>0) of domains in which the alignment directions of liquid crystal molecules when a voltage is applied are the same.

3. The liquid crystal display according to claim 1, comprising:
a facing substrate arranged so as to face the drive substrate; and
polarizing plates arranged on the drive substrate and the facing substrate,
wherein the top sides and bottom sides of the divided subpixel electrodes each form an angle of 45° with the optical axes of the polarizing plates.

4. The liquid crystal display according to claim 3, wherein
the plurality of subpixel electrodes constitute one pixel electrode, and
the outside shape of the pixel electrode is a trapezoid in which the right side and the left side are parallel to the optical axes of the polarizing plates, and the top side and the bottom side are inclined at 45°, 135°, 225° or 315° with respect to the optical axes of the polarizing plates.

5. The liquid crystal display according to claim 4, wherein
in the pixel electrode, a polarity relationship between the plurality of subpixel electrodes is opposite to that in adjacent pixel electrodes on the top and bottom sides or the right and left sides of the pixel electrode.

6. The liquid crystal display according to claim 4, wherein
the pixel electrode is point-symmetrically arranged with adjacent pixel electrodes on the top and bottom sides of the pixel electrode, and the top and bottom sides of the pixel electrode and the top and bottom sides of adjacent pixel electrodes on the top and bottom sides of the pixel electrode are parallel to one another.

7. The liquid crystal display according to claim 4, wherein
the pixel electrode is line-symmetrically arranged with adjacent pixel electrodes on the right and left sides of the pixel electrode with respect to a vertical axis.

8. The liquid crystal display according to claim 3, wherein
the plurality of subpixel electrodes constitute one pixel electrode,
the outside shape of the pixel electrode is a shape in which the top side and the bottom side are inclined at 45°, 135°, 225° or 315° with respect to the optical axes of the polarizing plates.

9. The liquid crystal display according to claim 8, wherein
the top and bottom sides of the pixel electrode and the top and bottom sides of adjacent pixel electrodes on the top and bottom sides of the pixel electrode are parallel to one another.
